(19) United States
(12) Patent Application Publication
(10) Pub. No.: US 2026/0022685 A1
(43) Pub. Date: Jan. 22, 2026

(54) WIND POWERED GENERATION SYSTEM

(71) Applicant: Studman Innovations Pty Ltd, City Beach, Western Australia (AU)

(72) Inventor: Brian George Studman, City Beach (AU)

(21) Appl. No.: 18/995,701

(22) PCT Filed: Jul. 20, 2023
(86) PCT No.: PCT/AU2023/050666

§ 371 Date: Jan. 16, 2025

(30) Foreign Application Priority Data
Jul. 20, 2022 (AU) 2022902021
Oct. 10, 2022 (AU) 2022252706

(51) Int. Cl. F03D 9/34; F03D 1/02; F03D 1/04; F03D 9/11; F03D 9/25

(52) U.S. Cl. CPC F03D 9/34; F03D 1/025; F03D 1/041; F03D 1/048; F03D 9/11; F03D 9/25; F05B 2220/706; F05B 2240/13; F05B 2240/9112; F05B 2260/42

(57) ABSTRACT

A diversely useful wind power generation system for use with an existing structure such as a building. The system has one or more wind capture funnels located at a first location of the existing structure such as at or adjacent its roof. An air pressure powered rotor mechanically coupled to a generator at a second location of the existing structure, such as inside or at ground level. A conduit fluidly connects the one or more wind capture funnels at the first location to the air pressure powered rotor at the second location of the existing structure.

### FIELD OF THE INVENTION

The invention relates to a wind power generation system. In particular, the invention relates, but is not limited, to a diversely useful wind power generation system for attachment to existing structure such as, for example, a building or tower.

### BACKGROUND TO THE INVENTION

Reference to background art herein is not to be construed as an admission that such art constitutes common general knowledge.

As mass electrification of the world continues, particularly with new loads such as electrified vehicles, power generation has become an increasingly important issue. With climate change, there is significant pressure on renewable power generation methods. Various forms of wind power generators have been developed to try to harness the power of the wind. These are usually in the form of tall towers with very large blades (often over 50 m, and in some cases over 100 m, long) spinning in fields, on hills, in the sea, or other locations where there is a relatively steady wind pattern. However, such large installations are not only very expensive and require a large area of land, but they are often in remote locations and power distribution needs to be implemented which adds significant additional complexity, cost, and efficiency losses. Furthermore, they create significant noise pollution and are ineffective at high wind speeds.

Consumer driven distributed power generation has grown in recent years with the advent of lower cost solar installations that allow homeowners to install solar panels on their rooftops. A significant downside of such systems is that they only generate electricity during the day when the sun is shining. At night, electricity must be drawn from the grid or some form of power storage, such as home batteries that may be charged during the day. When considered collectively, this has changed the electricity grid load profile significantly and caused problems for existing power distribution and generation infrastructure.

Unlike solar, wind power has the potential to harness the power of the wind over a 24 hour period. Small scale wind generators can be found on boats and caravans, for example. However, their power generation capacity is limited and could not supply a house, factory, city office blocks, or supply meaningful power into the electricity grid. Their design is not easily scaled up to increase power generation, at least not without inheriting the significant downfalls of large-scale wind turbines (e.g. significant size required, noise pollution, cost of tower, etc).

### OBJECT OF THE INVENTION

A proposed model of a small scale wind powered electrical generation system may divide the components of wind-powered generation into three separate functional components. This system recognises that between the wind collection device and the wind processing devices processing the wind into electrical energy there can be a wind transmission stage. For example, a separate component between a funnel wind collector and a generator can be a wind conductor. The inclusion of a wind conductor may facilitate diverse use of smaller cheaper components enabling economical production of electricity from small scale components.

It is an aim of this invention to provide a wind powered generation system which overcomes or ameliorates one or more of the disadvantages or problems described above, or which at least provides a useful alternative.

Other preferred objects of the present invention will become apparent from the following description.

### SUMMARY OF INVENTION

In one form, although it need not be the only or indeed the broadest form, there is provided a diversely useful wind power generation system for use with an existing structure such as a building, the diversely useful wind power generation system comprising:
one or more wind capture funnels located at a first location of the existing structure;
an air pressure powered rotor mechanically coupled to a generator at a second location of the existing structure; and
a conduit fluidly connecting the one or more wind capture funnels at the first location of the existing structure to the air pressure powered rotor at the second location of the existing structure.

The conduit may be attached to the existing structure. The conduit may be attached externally to the existing structure. The conduit may be attached to a wall of the existing structure. The conduit may be attached a roof of the existing structure. The existing structure may be a building. The building may be a house, factory, office block, sky scraper, or the like. The existing structure may be a tower. The first location may be at or near a roof of the existing structure. The second location may be located inside the existing structure. The second location may be located at or near a ground level of the existing structure.

The one or more wind capture funnels may be rotatably attached to the conduit. The one or more wind capture funnels may be rotatably attached to the conduit via an annular swivel connection through which air can travel. The one or more wind capture funnels comprise a filter. The filter may comprise a mesh. The filter may comprise a gauze.

The diversely useful wind power generation system may further comprise one or more pressure release valves. The one or more pressure release valves may be in fluid communication with the conduit. The one or more pressure release valves may be configured to release air pressure from inside the conduit when the air pressure exceeds a predetermined maximum. The one or more pressure release valves may vent excess pressure into the atmosphere. The one or more pressure release valves may be located at one or more locations along the conduit.

The air pressure powered rotor may comprises a plurality of air pressure powered rotors. The plurality of air pressure powered rotors may be arranged in series. The air pressure powered rotors may reduce in diameter along the series in a direction of air flow. The plurality of air pressure powered rotors arranged in series may be axially aligned. The plurality of air pressure powered rotors may be located within a casing. Each of the plurality of air pressure powered rotors may be mechanically coupled its own generator at the second location. The casing may taper between each rotor. The casing may taper between each rotor to account for a reducing diameter of the rotors along a series. The casing may taper between each rotor to account for the reducing diameter of the rotors along the series and to funnel air in the casing as the rotors reduce in size. Each rotor may be mounted to a shaft of a separate generator. Each generator may be held centrally within the casing by struts.

The air pressure powered rotor may comprise at least three blades. The blades of the air pressure powered rotor may be curved or angled. The blades of the air pressure powered rotor may have overlapping portions. The blades of the air pressure powered rotor may have overlapping edges.

The one or more wind capture funnels may comprise a rudder. The rudder may be a tail rudder. The funnel may comprise a face. The face may comprise a wide-open end. The rudder may be attached to an opposite side of the funnel to the wide-open end. The rudder may be configured to direct a face of the funnel into prevailing wind. The funnel may be circular in cross-section. The funnel end may be square in cross-section or any other shape.

The generator may be coaxially arranged with the air pressure powered rotor. The generator may be integrated with the air pressure powered rotor. The generator may be located in a centre of the air pressure powered rotor. The air pressure powered rotor and generator may be mechanically coupled by a common shaft.

In another form, there is provided a method of installing and using a diversely useful wind power generation system to an existing structure such as a building, the method comprising the steps of:
mounting a conduit to one or more of a wall and a roof of the existing structure;
installing one or more wind capture funnels to one or more inlets of the conduit at a first location of the existing structure;
fluidly connecting an air pressure powered rotor to an outlet of the conduit at a second location of the existing structure; and
generating electricity using wind pressure received by the one or more wind capture funnels using a generator mechanically coupled to the air pressure powered rotor.

The method may further comprise the step of fluidly connecting one or more further air pressure powered rotors in series at the second location of the existing structure, wherein each air pressure powered rotor is mechanically coupled to its own generator. The air pressure powered rotors may be arranged in series inside a casing. The air pressure powered rotors may reduce in diameter along the series. The step of mounting a conduit to one or more of a wall and a roof of the existing structure may comprise mounting the conduit externally to the existing structure.

The method may further comprise the step of transmitting electricity generated by the generator(s) to one or more of storage batteries or an electricity grid. The diversely useful wind power generation system used in the method is preferably as hereinbefore described. Each generator may have a rotor mounted to its shaft that is held centrally within the casing by struts. The casing may taper between each rotor to account for a reducing diameter of the rotors along the series. The tapering of the casing may funnel air in the casing as the rotors reduce in size.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a diagrammatic perspective view of a diversely useful wind power generation system having a single funnel;

FIG. 2 illustrates a diagrammatic perspective view of a diversely useful wind power generation system having a plurality of funnels;

FIG. 3 illustrates a diagrammatic cross-sectional view of a rotor and power generation portion of a diversely useful wind power generation system having a single rotor and generator; and

FIG. 4 illustrates a diagrammatic cross-sectional view of a rotor and power generation portion of a diversely useful wind power generation system having a plurality of rotors and generators.

### DETAILED DESCRIPTION OF THE DRAWINGS

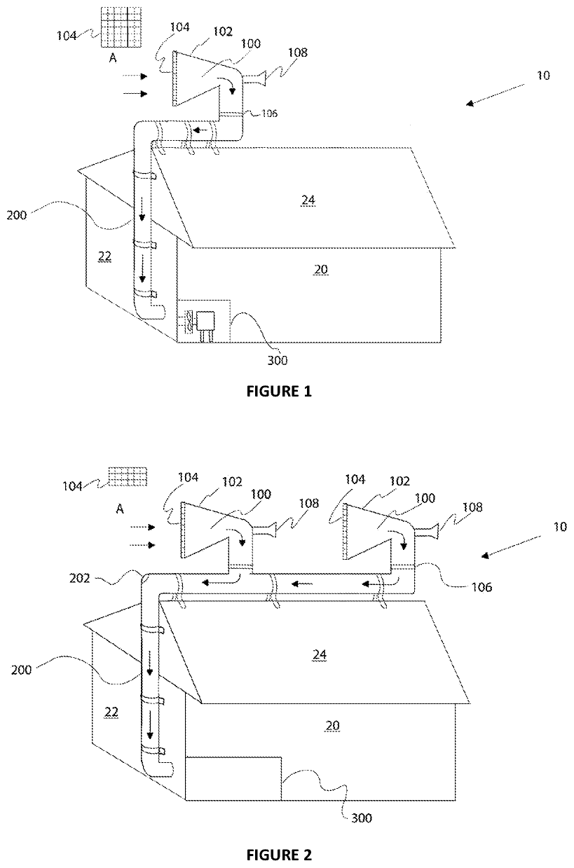

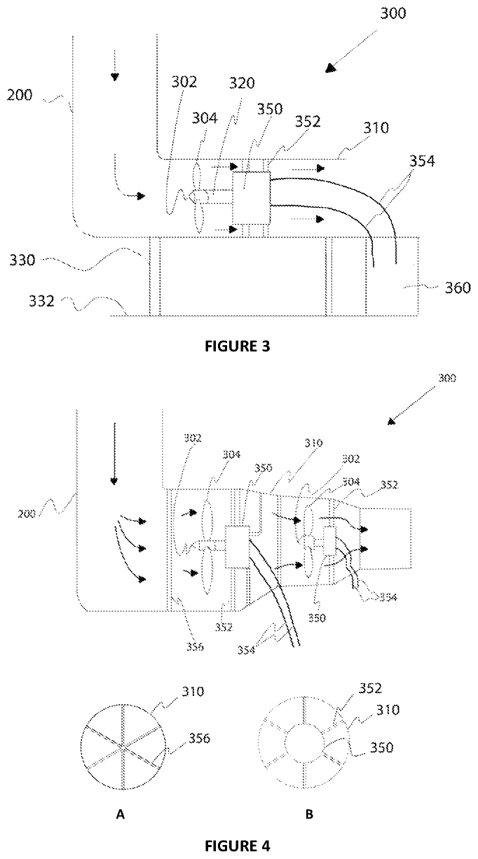

FIG. 1 illustrates a diversely useful wind power generation system 10 attached to an existing structure in the form of a building 20. It includes a wind capture funnel 100, a wind conductor tube in the form of a conduit 200, and an air driven rotor generator system 300 which is described with further detail with reference to FIGS. 3 and 4.

The wind capture funnel 100 has a wide-open end 102 having a filter 104 mounted thereto. A front view of the filter 104 showing a mesh or gauze is provided at ‘A’. The funnel 100 is rotationally mounted to an inlet of the conduit 200 via a rotatable mount 106. The rotatable mount 106 allows the funnel 100 to swivel with respect to the conduit 200 which allows the funnel to rotate and always face the direction of the prevailing wind.

The funnel 100 also has a tail rudder 108 at an opposite side of the funnel 100 to the open end 102 to direct the open face of the funnel 100, with filter 104 thereon to deflect debris and other foreign matter from entering, into the prevailing wind.

The conduit 200 is mounted to a wall 22 and roof 24 of the building 20. The conduit 200 may be of any suitable length and may take any suitable path so long as it fluidly connects the funnel 100 at a first location of the building 20 to the air driven generation system 300 at a second location of the building 20. The conduit 200 fluidly communicates wind collected by the funnel 100 into the air driven generation system 300.

The conduit 200 can be constructed of any suitable material such as, for example, steel tubing or plastic pipe, depending on the strength of the wind and nature of the building 200 to which it is mounted. The surface area of the wind capturing funnel 100 should be several times more than the surface area of the conduit 200 such that the wind speed and/or air pressure can be significantly increased by using a much smaller cross-sectional surface area conduit 200.

FIG. 2 illustrates a diversely useful wind power generation system 10 that is similar to the system illustrated in FIG. 1 but has a plurality of wind capture funnels 100 rotatably mounted to the conduit 200. This arrangement allows channeling of wind into the same conduit 200. It should be appreciated that more than two funnels 100 could be fluidly connected to the same conduit 200. This not only allows a greater wind collection area, but also allows wind to be collected from more than one location.

It should be appreciated that the funnel 100 can be any suitable shape such as, for example, rectangular, square, or variously shaped. A variously shaped funnel can be used to channel a wider surface area of wind into a smaller surface area of wind and therefore increase the velocity and/or air pressure of the wind. As the wind travels through a tapered funnel 100 it increases in velocity and/or pressure as the same volume of wind is driven into a smaller space. More air in less space means higher air pressure and faster movement of the air/wind. Three square meters of funnel 100 surface area may be able to be channeled into a one square meter area conduit may would result in three times the velocity of the wind travelling therethrough.

It is envisaged that using a conductor tube of 0.5 square metre cross-sectional area with funnels having a six square metre cross-sectional area would increase the wind speed up to 24 times its initial speed. A 5 knot wind may therefore be able to produce a wind speed of up to 120 knot wind inside the conduit 200 allow for significant electricity to be produced at relatively low wind speeds.

FIG. 2 also illustrates a pressure release valve 202 located in the conduit 200. The pressure release valve 202 is a safety mechanism configured to be opened upon air pressure in the conduit 200 reaching a predetermined maximum. It can prevent excessively high velocity and/or pressure wind from overloading the air driven generation system 300. When the pressure release valve 202 is actuated, excess high velocity and/or pressure wind can be vented to the atmosphere. The pressure release valve may be optional as it should only be needed in very high velocity wind areas. It may also be required in some jurisdictions as a safety feature. Although the pressure release valve 202 is located at a corner of the conduit 200 in FIG. 2, no limitation is meant thereby and it should be appreciated that the pressure release valve 202 could be located elsewhere so long as it is in fluid communication with the conduit 200. Furthermore, it should also be appreciated that more than one pressure release valve 202 may be installed at various locations along the conduit 200 and/or even in the air driven generation system 300.

FIG. 3 illustrates an air driven generation system 300 in greater detail. In fluid communication with the conduit 200 is a rotor 302 mechanically coupled to a generator 350 via a common shaft 320. The rotor 302 has a plurality of blades 304. In preferred forms there are at least three blades 304 that are angled or curved with overlapping edges that collectively cover the surface area of casing 310 within which the rotor 302 is located. The generator 350 is mounted inside the casing 310 by support structure 352. The rotor 302 is suspended centrally inside the casing 310 by the shaft 320. Electrical wires 354 electrically connect the generator 350 to a battery system 360 or to the power grid (not shown), via an inverter or the like. The air driven generation system 300 may be supported by stands 330 that support the casing 310, with rotor 302 and generator 350 located therein, on a surface 332 such as, for example, the ground, a basement floor, or a top floor of a building.

FIG. 4 illustrates an air driven generation system 300 having a plurality of rotors 302 aligned in series along an axial axis. The second rotor 302 in the series has a smaller diameter than the first rotor 302 in the series. The casing 310 is correspondingly tapered between each rotor 302 to account for the reducing diameter of the rotors 302 along the series. Each rotor 302 and has an associated generator 350. Alternatively, a plurality of rotors 302 may be able to be connected along a common shaft to a single generator 350. It should also be envisaged that the one or more rotors 302 may be mechanically coupled to one or more generators 350 by alternative means such as, for example, belts, chains, and/or gears.

In this form, wind from the first rotor can travel from the conduit 200 into the casing 310 and traverse the series of rotors 302. The second (and any further rotors 302 and generators 350) are preferably slightly smaller in size than the preceding rotor 302 and generator 350. Processing of the wind several times can be achieved by using air-tight tapered casing 310 to contain and direct the air as the rotors 302 reduce in size. The casing 310 may be made of any suitable material including, for example, steel.

With a large casing 310 inlet, as shown in FIG. 4, support beams, illustrated in the form of struts 356 at cross-sectional view ‘A’ of FIG. 4, may be provided inside the casing 310. The struts 356 may extend radially and cross one another, preferably centrally, for added strength. The struts 356 are preferably narrow to provide minimal air resistance and allow air to flow as unobstructed as possible through the casing 310. As can be seen at cross-sectional view ‘B’ of FIG. 4, the support structure 352 holding the generator 350 also preferably extends radially within the casing 310 to hold the generator 350, and also hence rotor 302, centrally therein.

In preferred construction, a building roof top 24, or the like, in a windy area of an existing structure is first selected. The conduit 200 is attached to the roof 24 by suitable fastenings such as, for example, steel straps bolted to the roof 24. The funnels 100, with filter 104, rotatable mount 106, and rudder 108 attached, are connected to the conduit by suitable means such as, for example, welds or a seal and bolts. The conduit 200, with any safety valves 202 attached, can be extended with tubing, or the like, to the casing 310 surrounding the rotor generator system 300. The rotor 304 and generator 350 assembly can be bolted to the support structure 352 located inside the casing 310.

In use, the system 10 can be assembled in a windy area where electricity is needed. The one or more funnels 100, with filter 104 covering over the open face of the funnels 100 and rudder 108 for directing the funnels 100 towards the prevailing wind, are erected on a roof top 24 or other elevated position to collect and compress incoming wind. The funnels 100 are connected to a variously shaped tube in the form of conduit 200 to transport the wind to the rotor generator system 300 located at a different location from the funnels 100. The conduit 200 may have pressure release valves 202 positioned in one or more locations as needed. These pressure release valves 202 serve to release excess pressure in the conduit 200 to prevent damage to the rotor generator system 300 and other components. Conveyed wind is channeled into a casing 310 which contains one or more rotors 302 and generators 350. The rotors 302 and generators 350 are supported within the casing 340 by a support structure 352. The support structure serves to hold the rotors 302 and generators 350 in a fixed place therein and prevent the blades 304 of the rotors 302 from connecting with the casing. The compressed wind is channeled through the blades 304 which rotate the rotors 302 and in turn rotate the shaft mechanically coupled to a generator 350. The rotating shaft turns the shaft 320 and the generator 350 converts the mechanical energy into electricity which can be conducted via wires 354 to either batteries for storage 360 or into the electrical grid for use by consumers.

Advantageously, the diversely useful wind power generation system provides a small-scale and multi-use system that can over-come many of the inadequacies of large scale remotely located wind power generation systems. Smaller rotors are more economically viable and can be located in cities, factories, farm sheds, houses, house garages, or the like. Smaller rotors, located in contained rooms or basements of buildings are much quieter and economically viable than huge remotely located rotors. Furthermore, distributed power generation can reduce transmission losses as more electricity can be consumed at or near the source of generation.

The diversely useful wind power generation system also allows generation overnight unlike home rooftop solar systems. The diversely useful wind power generation system can be used in tandem with a rooftop solar system to increase and supplement power generation providing more stable and reliable power generation over different days and seasons. It can be used to charge batteries or it can be tied to the electricity grid and export any excess electricity as needed.

Using two or more funnels, as wind collectors, connected to a common conduit enables a greater volume of air pressure to be converted into electricity than can be achieved by a single funnel of the same size. The surface area of a series of funnels located on a huge shed, for example, could exceed the circumference of a city-based rotor blade. Additionally, industrial wind turbines have rotor blades have huge gaps between their blades. In contrast, the funnel wind collectors do not have any such gaps and therefore capture all the wind flowing therein.

Using one or more funnels and a conduit also enables the wind to be captured from a variety of locations. Using a conduit to transfer the wind enables a smaller rotor to be used and the generator can be located where convenient such as, for example, on the ground or in a ceiling cavity of a house, or on the top floor of a high-rise building, for example. The present system can use a tower but advantageously reduces the size, strength, and cost of the tower support system as it does not need to support the weight and load of the generator. A generator located in the base of a building, or under the roof of a building roof, for example, is easier and cheaper to access and service/maintain than a rotor located on industrial wind turbines, particularly those located at sea.

The funnels and conduit may be shaped as needed for manufacture and functional purposes. This allows the rotor and generator system to be placed at a more convenient and cost-effective locations such as, for example, on the basement of a building or top floor of a high-rise building. Improved accessibility at such locations also reduces maintenance and repair costs.

Using two or more rotor generators in series inside an air tight casing enables the same air volume to be processed two or three times (or more, although there are diminishing returns). Each rotor and generator may be co-located on a single shaft that is separate and independent from the next rotor and generator combination in the same series. This method of manufacture may enable a greater level of electricity to be generated from the same volume of wind compared to processing the wind only once.

By having a series of rotors and generators each of decreasing size encapsulated in a common casing enables the wind processed into electricity by the first rotor generator system to be processed a second and third time by smaller rotors and generators. This can increase the electric power generated from the same volume of wind. Processing the same volume of wind several times means that this wind generator can increase the total supply electricity from low wind velocities and may meet the needs of small factories, residences, and farms etc. It could enable city dwellers to supply their own electricity for home use and possibly even charge electric vehicles.

Multiple wind funnel collectors connected to one or more conduits 200 communicating the wind to one or more rotors and generators allows the system to have flexibility to adapt to a wide range of situations and wind velocities. The system could also be adapted to produce wind powered electricity on oil rigs, farms, wheat storage bins at ports, etc. A preferred objective of the system is to significantly increase the production and use of wind powered electricity generation and reduce the consumption of fossil fuels.

Having a pressure release valve may improve safety and durability of the system by enabling excessively high velocity or pressure wind to escape the system. The pressure release valve would open when the velocity and/or pressure of the wind in the conduit exceeds a predetermined maximum level. The pressure release safety valve could prevent damage to the funnels, supporting structure, rotors, and generators by excessive wind conditions.

The filter on the funnels advantageously serves to prevent birds, insects, sticks, leaves, and other foreign objects from entering the funnel(s) and subsequently damaging the rotor(s) or generator(s).

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of wind sourced electrical power generation. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A diversely useful wind power generation system for use with an existing structure such as a building, the diversely useful wind power generation system comprising:
one or more wind capture funnels located at a first location of the existing structure;
a plurality of air pressure powered rotors each mounted to a shaft of a respective generator at a second location of the existing structure, the air pressure powered rotors and generators being arranged in series inside a casing and reducing in diameter along the series; and
a conduit fluidly connecting the one or more wind capture funnels at the first location of the existing structure to the casing, air pressure powered rotors and generators at the second location of the existing structure;
wherein each generator is held centrally within the casing by struts and the casing tapers between each rotor to account for the reducing diameter of the rotors along the series and to funnel air in the casing as the rotors reduce in size.

2. The diversely useful wind power generation system of claim 1, wherein the conduit is attached and extends externally to the existing structure.

3. The diversely useful wind power generation system of claim 1, wherein the one or more wind capture funnels are rotatably attached to the conduit.

4. The diversely useful wind power generation system of claim 1, wherein the one or more wind capture funnels comprise a filter at the wind capture funnel entrance.

5. The diversely useful wind power generation system of claim 1, further comprising one or more pressure release valves in fluid communication with the conduit, the one or more pressure release valves being configured to release air pressure from inside the conduit when the air pressure exceeds a predetermined maximum.

6. The diversely useful wind power generation system of claim 1, wherein the plurality of air pressure powered rotors and generators arranged in series are axially aligned.

7. The diversely useful wind power generation system of claim 1, wherein each of the plurality of air pressure powered rotors are mechanically coupled to its own generator at the second location.

8. The diversely useful wind power generation system of claim 1, wherein the air pressure powered rotor comprises at least three blades that are curved or angled and have overlapping portions.

9. The diversely useful wind power generation system of claim 1, wherein the existing structure is a building and the conduit is mounted to one or more of a wall and a roof of the building.

10. The diversely useful wind power generation system of claim 1, wherein the first location is at or near a roof of the building and the second location is located inside the building or adjacent to the building.

11. The diversely useful wind power generation system of claim 1, wherein each of the one or more wind capture funnels each comprise a rudder.

12. The diversely useful wind power generation system of claim 1, wherein each generator is coaxially arranged with each air pressure powered rotor.

13. The diversely useful wind power generation system of claim 1, wherein each air pressure powered rotor and generator are colocated on a single shaft that is separate and independent from the next rotor and generator combination in the same series.

14. The diversely useful wind power generation system of claim 1, wherein a plurality of wind capture funnels are fluidly connected at different locations to the same conduit.

15. A method of installing and using a diversely useful wind power generation system to an existing structure such as a building, the method comprising:
mounting a conduit to one or more of a wall and a roof of the existing structure;
installing one or more wind capture funnels to one or more inlets of the conduit at a first location of the existing structure; and
fluidly connecting a casing containing a plurality of air pressure powered rotors to an outlet of the conduit at a second location of the existing structure, the air pressure powered rotors being arranged in series inside the casing and reducing in diameter along the series with the casing tapering between each rotor to account for the reducing diameter of the rotors along the series and to funnel air in the casing as the rotors reduce in size; and generating electricity using wind pressure received by the one or more wind capture funnels using a plurality of generators each having an air pressure powered rotor mounted to its shaft and being held centrally within the casing by struts.

16. The method of claim 15, wherein the step of mounting a conduit to one or more of a wall and a roof of the existing structure comprises mounting the conduit externally to the existing structure.

17. The method of claim 15, further comprising the step of transmitting electricity generated by the generator(s) to one or more of storage batteries or an electricity grid.

18. (canceled)

19. The method of claim 15, wherein a plurality of wind capture funnels are fluidly connected at different locations to the same conduit.
